(19) United States
(12) Patent Application Publication
(10) Pub. No.: US 2010/0019578 A1
(43) Pub. Date: Jan. 28, 2010

(54) Power Converter for Solar Electrical Current Installations and Method for Controlling it

(75) Inventor: Dejan SCHREIBER, Numberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: SEMIKRON Elektronik GmbH & Co. KG, Numberg (DE)

(21) Appl. No.: 12/509,296

(22) Filed: Jul. 24, 2009

(30) Foreign Application Priority Data
Jul. 26, 2008 (DE) 10 2008 034 954.2

(51) Int. Cl. H02J 1/00

(52) U.S. Cl. 307/82

(57) ABSTRACT

A power converter arrangement with a plurality of d.c voltage inputs of a chronologically varying input voltage, preferably from a solar cell arrangement, is described. In this case, every d.c. voltage input is connected with an associated converter cell, which in turn has at least one step-up converter connected with the input poles, and a recovery diode arranged between the two output poles. Furthermore, the output poles of the converter cells are connected in series and thus constitute the summed d.c. voltage output. The associated method regulates the pulse width of the step-up converter of each converter cell in such a way that the power output of the converter cell fluctuates around the actual theoretical maximum value.

### BACKGROUND OF THE INVENTION

1. Field of the Invention

The invention is directed to a method for controlling a power converter and to such a converter having a plurality of d.c voltage inputs, preferably from a solar cell arrangement, and also having a summed d.c. voltage output. Such a power converter arrangement is suited for various applications which have a plurality of d.c. voltage inputs with time-varying d.c. input voltage.

2. Description of the Related Art

Solar cells having individual panels arranged in a two-dimensional matrix are known. The individual panels of individual columns and rows of this matrix are connected in series and therefore constitute a solar panel chain. It is furthermore known to connect such solar panel chains in parallel, and, in the process, to connect the output poles of this connection with an electrical network by means of a d.c./a.c. converter to feed electrical current to the network. A solar electrical current installation of this type is generally inexpensive, but suffers from some disadvantages.

For example, it is disadvantageous that the output voltage of such installations, as well as their power output, greatly vary as a result of the effective illumination intensity. With the mentioned solar electrical current installation, it is particularly disadvantageous that switching off an individual panel leads to a greatly overproportional reduction of the power output of its solar panel chain. Thus, the actual degree of efficiency of such a solar power installation is far less than the theoretical maximum degree of efficiency at a given illumination intensity.

It is also known to connect individual solar panel chains directly with an assigned d.c./a.c. converter and to connect the a.c. voltage outputs of these individual d.c./a.c. converters with the electrical network. Here, the manufacturing costs are considerably greater than in the first-mentioned embodiment. However, advantageously these costs do provide a greater actual degree of efficiency.

A solar electrical current installation with one d.c./a.c. converter per individual panel would achieve an optimal degree of efficiency along with the greatest costs at the same time. However, this design makes less economical sense because of its increased cost.

### SUMMARY OF THE INVENTION

It is an object of the invention to provide a power converter which is used for the further development of a solar electrical current installation having an improved efficiency and reduced manufacturing cost.

Briefly stated, the invention is directed to a solar electrical current installation, preferably with a plurality of solar panel chains, each such chain having a time-varying d.c. voltage output, and with the value of this voltage, which preferably is the maximum value of the no-load voltage of a solar panel chain. These d.c. voltage outputs of the solar panel chains constitute the d.c. voltage inputs of the inventive power converter.

Each d.c. voltage input of the inventive power converter is connected with an associated converter cell, which in turn has at least one step-up converter connected with the input poles, and a recovery diode. These converter cells are connected in series by means of their output poles and in this way constitute a summed d.c. voltage output of the power converter.

Such a power converter arrangement is preferably arranged directly adjoining the solar cell arrangement and is connected via a d.c. connection with a d.c./a.c. converter, thereby forming a solar current installation.

In accordance with the inventive method for controlling such a power converter, the pulse width, i.e. the ratio of the switch-on time to the total length of a switching period, of the step-up converter of each converter cell is selected so that the power output of the converter cell fluctuates around the theoretical maximal value. For this purpose, the input d.c. voltage and the current in the step-up converter are preferably measured. In this case, the output voltage of the respective converter cell is set between the actual output voltage and the no-load voltage of the voltage source which can be connected with the d.c. voltage input. It is preferred that the fluctuation around the maximum value of the power output be no more than 10% of maximum.

Together with the method in accordance with the invention, the design of the inventive power converter has the advantage that a solar electrical installation produced by means of this power converter arrangement has an improved ratio of the actual degree of efficiency and cost. This is achieved in that, matched to the actual illumination intensity, and therefore to the actually possible maximum value of the power output of the individual solar panel chains, voltage is supplied to a d.c. voltage connection by a d.c./a.c. converter. Moreover, the usefulness of the d.c. connection over an a.c. connection has the known advantage that the transmitted output is greater by the factor of the square root of 2.

Particularly preferred further embodiments of this circuit arrangement and its control methods are mentioned in the respective description of the exemplary embodiments. Moreover, the attainment of the object in accordance with the invention will be further explained by means of the exemplary embodiments in FIGS. 1 and 2.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a converter cell of the inventive power converter; and

FIG. 2 shows the inventive power converter in a solar electrical installation.

### DETAILED DESCRIPTION OF THE PRESENTLY PREFERRED EMBODIMENTS

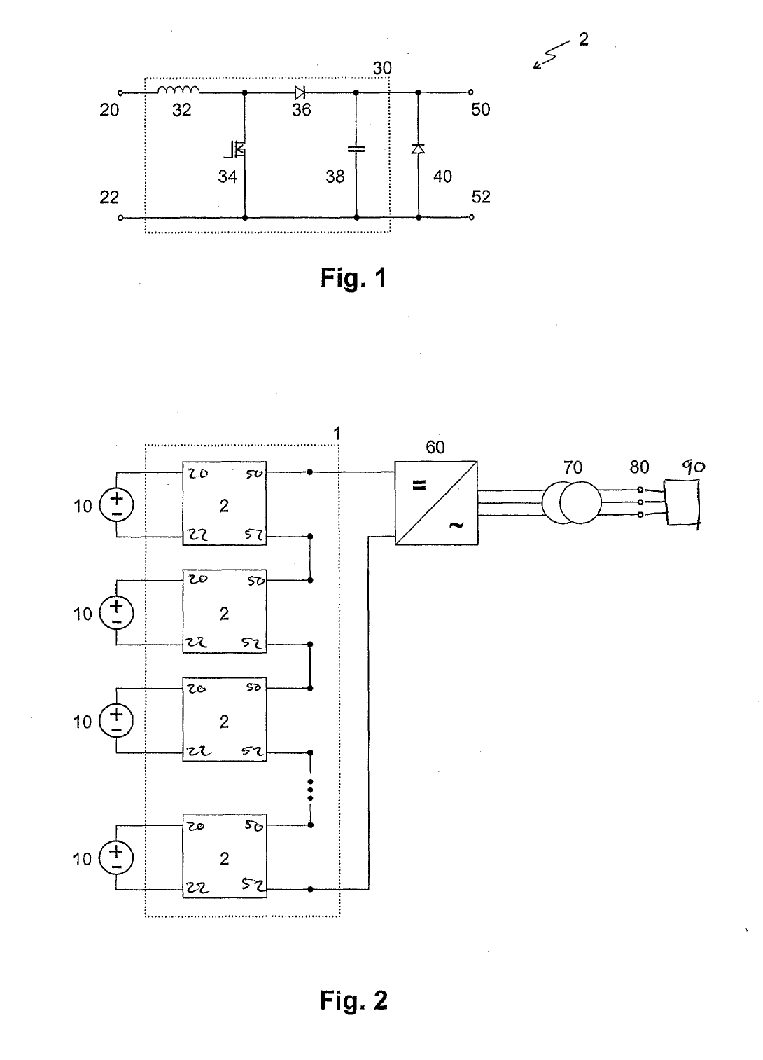

FIG. 1 represents a converter cell 2 of a power converter 1 in accordance with the invention. Converter cell 2 has a d.c. voltage input with a positive input pole 20 and a negative input pole 22. Positive input pole 20 is connected with a coil 32 of a step-up converter 30. Coil 32 is furthermore connected with the anode of a diode 36 of step-up converter 30, as well as with a switch 34. Here, a power MOSFET has been provided as the switch although other types of switches may be employed. The cathode of diode 36 is connected with a first connector of a capacitor 38. Switch 34 is also connected with the negative input pole 22 of converter cell 30 and with a second connector of capacitor 38.

Step-up converter 30 is connected with the positive and negative output poles 50 and 52 of the d.c. output of converter cell 2. A recovery diode 40 bridges output poles 50, 52 in the throughput direction. For controlling step-up converter 30, the input d.c. voltage between input poles 20, 22 and the electrical current, preferably downstream of coil 32, are measured, and from this, the pulse width of switch 34 is determined. The power output of converter cell 2 lies as closely as possible to the maximum value of the output of step-up converter 30.

FIG. 2 shows power converter 1 in a solar electrical installation. Here, respectively one solar panel chain 10 is connected with inputs 20, 22 of an assigned converter cell 2. The respective outputs 50, 52 of these converter cells 2 are serially connected with each other, so that the output voltages of the respective converter cells 2 are added together and constitute the summed d.c. voltage output. This summed d.c. voltage output is connected with a d.c./a.c. converter 60 by means of a d.c. connection line which, for feeding-in electrical current, is connected via a transformer 80 to an electrical network 90.

In case of a mechanically caused failure of a converter cell 2, for example, the recovery diode 40 is used for bridging converter cell 2, so that, because of the in-series connection, the current flow from the chain is not interrupted.

The input voltages, as well as the input current, of the respective converter cells 2 may fluctuate rapidly in the course of a day as a result of passing shadows, or slowly as a result of normal variations in the solar illumination intensity. In accordance with the prior art, for controlling the power output of a solar panel chain, the current is readjusted in such a way that the maximum output of a solar panel chain is available. Here, the output voltage follows as a function of the set current.

In accordance with the invention, the step-up converters 30 of the respective converter cells 2 are in principle controlled independently of each other in such a way that the power output of each respective converter cell 2 reaches the actually possible maximum output.

Not taking small switching losses into consideration, the power input, i.e. the product of input current and input voltage, is equal to the power output. Typical values of the input voltage lie below 50V, for example, wherein 50V is the typical no-load voltage of a solar panel chain as a function of known factors, such as temperature and radiation intensity. Thus, for a regulation to achieve the actually possible maximum output, the output voltage is regulated accordingly, with the output current as a given.

Converter cell 2 is therefore controlled so that the respective value of the output voltage does not exceed the value of the no-load voltage and lies here between the value of the input voltage and maximally the value of the no-load voltage. In this case, the output current of a converter cell does not exceed the value of the input current.

In order not to let the summed output voltage fall below a fixed minimum value, it can be advantageous to match the above mentioned regulation to the maximum value by means of the described tolerance in order to assure the operation of a downstream connected d.c./a.c. converter 60 as a function of the technical specifications.

By way of example, power semiconductor elements of the voltage class 1200V are employed in the downstream connected d.c./a.c. converters 60. In case of a three-phase a.c. voltage output of this d.c./a.c. converter 60 of 3×400V, its required intermediate circuit voltage lies at 650V, however, up to 900V is tolerable here. But in accordance with the prior art, the a.c. voltage output, and therefore the input voltage of a downstream-connected transformer 70, is set to only 3×270V. The reason for this lies in the relatively great voltage fluctuations of the solar cell arrangement. The maximum value of its output lies for example at 900V, sometimes even at 1000V. In this case, a ballast resistor (not shown) may be switched in for lowering the output voltage to 900V. Since, in this example, in accordance with the prior art, the intermediate circuit voltage is relatively low at 430V, the output voltage of the a.c./d.c. converter is only 3×270V, because of which the a.c./d.c. converter currents are correspondingly large. Thus, a 500 kW solar installation in accordance with the prior art has an effective current of 1080 A. The power converter arrangement in accordance with the invention, which has also been designed for input voltages up to 900V, generates an output voltage of 3×400V, because of which the effective current lies only at 722 A.

Within a large range, the inventive method for controlling such an a.c./d.c. converter makes it possible to provide a summed output voltage of the converter cells, independently of the different outputs of the individual solar panel chains, to make possible a high degree of efficiency of the d.c./a.c. converter. In this fashion, it is possible to improve the actual degree of efficiency of a solar current installation with comparatively low cost.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power converter for converting power received from a plurality of d.c voltage inputs of a time-varying input voltage having a maximum value, the d.c. voltage inputs each having input poles, the power converter comprising:
a plurality of converter cells, each connected to a respective d.c. voltage input, each converter cell having
a step-up converter connected with the input pole of the respective d.c. voltage input;
a recovery diode electrically disposed between the positive and negative output poles of the respective d.c. voltage input; and
an output pole;
wherein said output poles of said converter cells are connected in series and thereby produce a summed d.c. voltage output.

2. The power converter of claim 1, wherein the cathode of each said recovery diode is connected with said positive output pole of each said respective converter cell and the anode of each said recovery diode is connected with said negative output pole of each said respective converter cell.

3. The power converter of claim 1, wherein the power converter arrangement is connected with a d.c./a.c. converter by means of a d.c. voltage connection.

4. The power converter of claim 1, wherein the input voltage is from a solar cell.

5. A method for controlling a power converter, the power converter comprising;
a plurality of converter cells, each connected to a respective d.c. voltage input, each converter cell having
a step-up converter connected with the input pole of the respective d.c. voltage input;
a recovery diode electrically disposed between the positive and negative output poles of the respective d.c. voltage input; and
an output pole;
wherein said output poles of said converter cells are connected in series and thereby produce a summed d.c. voltage output;
the method comprising the steps of:
adjusting the pulse width of the step-up converter of each converter cell so that the power output of said converter cell fluctuates around the actual theoretical maximum value therefor,
measuring the input d.c. voltage and the current in said step-up converter, and
setting the output voltage of the respective converter cell between the actual output d.c. voltage input.

6. The method in accordance with claim 5, wherein the value of the input d.c. voltage of the respective converter cell varies between about 0V and about 50V, wherein 50V corresponds to the no-load voltage of the connectable voltage source.

7. The method in accordance with claim 5, wherein the fluctuation around the maximum value of the power output is no more than 10%.
